(19) United States
(12) Patent Application Publication
(10) Pub. No.: US 2008/0216952 A1
(43) Pub. Date: Sep. 11, 2008

(54) Adhesive Method Of Optical Components

(75) Inventors: Chien-Hung Yu, Taipei Hsien (TW); Chun-Yen Lin, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 11/682,585

(22) Filed: Mar. 6, 2007

(51) Int. Cl. B32B 37/12; B29C 65/52

(52) U.S. Cl. 156/272.2

(57) ABSTRACT

An adhesive method of adhering a first optical component to a second optical component includes applying a resin on a first predetermined area of the first optical component and a second predetermined area of the second optical component, and then arranging the first and second predetermined areas to correspond to each other, and then shortening the distance between the first and the second predetermined areas until a resin bridge being formed between the first and second optical components, and then lightly shortening the distance between the first and second predetermined areas for the resin being spread over the first and second predetermined areas, and then the resin being spread to be fully filled between the first and second optical components through the second optical component being released and pressing the resin, finally illuminating the resin through ultraviolet ray for engaging with the first and second optical components.

### BACKGROUND OF THE INVENTION

1. Field of the Invention

The invention relates to an adhesive method of optical components, and particularly to an adhesive method of optical components which are used in a liquid crystal display device.

2. The Related Art

Nowadays, a liquid crystal display device is a necessary component used in an electrical device for showing information such as texts, pictures and etc. According to the dimension of the liquid crystal display device, the liquid crystal display device is used in various electrical devices. A large size liquid crystal display device, for example, the dimension of the liquid crystal display device is larger than 20 inch, is used in a television. A middle size liquid crystal display device, for example, the dimension of the liquid crystal display device is smaller than 17 inch and larger than 12 inch, is used in a laptop. A small size liquid crystal display device, for example, the dimension of the liquid crystal display device is smaller than 10 inch, is used in a mobile phone, a personal digital assistant, a digital camera and etc.

A conventional liquid crystal display device is disclosed in U.S. Pat. No. 5,710,607. The liquid crystal display device includes a cover sequentially covering a backlight, a diffusion plate, a supporting substrate and a liquid crystal plane. A circuit board is located on the supporting substrate. A print-circuit film connects with the circuit board and the liquid crystal plane. A protective glass plate is arranged upon the liquid crystal plane, which connects with the cover of the liquid crystal display device.

Because a space is formed between the liquid crystal plane and the protective glass plate, the surface of the liquid crystal plane is covered with dust which intrudes through the space. The display quality of the liquid crystal display device is influenced by the dust covering on the surface of the liquid crystal plane. Further, the dimension of the liquid crystal display device can not be reduced because of the space between the liquid crystal plane and the protective glass plate.

A further conventional liquid crystal display device is disclosed in U.S. Pat. No. 5,659,376. The liquid crystal display device includes a housing which sequentially houses a backlight device, a diffusion plate, a fixing plate and a liquid crystal plane therein. A peripheral circuit plate is located on the fixing plate. A flexible printed wire film connects with the peripheral circuit plate and the liquid crystal plane. A protective plate is arranged upon the liquid crystal plane, which connects with the housing of the liquid crystal display device.

An elastic member is applied along the whole periphery surrounding the liquid crystal plane to partition an almost closed space between the liquid crystal plane and the protective plate. The elastic member prevents intrusion of dust onto the surface of the liquid crystal panel. However, the closed space between the liquid crystal plane and the protective plate influences downsizing of the liquid crystal display device.

### SUMMARY OF THE INVENTION

An object of the present invention is to provide an adhesive method of optical components.

According to the invention, the adhesive method has following steps:
Step 1: firstly, applying a resin on a first predetermined area of a first optical component and a second predetermined area of a second optical component;
Step 2: arranging the first predetermined area of the first optical component to correspond to the second predetermined area of the second optical component through a first supporting apparatus and a second supporting apparatus which support the first optical component and the second optical component respectively, and through a fixing device of the second supporting apparatus fixing the second optical component;
Step 3: shortening the distance between the first optical component and the second optical component until the resin applied on the first predetermined area of the first optical component being connected to the resin applied on the second predetermined area of the second optical component to form a resin bridge;
Step 4: after the resin bridge being formed between the first optical component and the second optical component, lightly shortening the distance between the first optical component and the second optical component to make the resin to spread over the first predetermined area and the second predetermined area;
Step 5: when the fixing device releasing the second optical component, the second optical component pressing the resin to make the resin to spread to be fully filled between the first optical component and the second optical component; and
Step 6: after the resin being fully filled between the first optical component and the second optical component, illuminating the resin through ultraviolet ray for the resin engaging with the first optical component and the second optical component.

### BRIEF DESCRIPTION OF THE DRAWINGS

The present invention will be apparent to those skilled in the art by reading the following description of a preferred embodiment thereof, with reference to the attached drawings, in which:

FIG. 1 is a flow chart showing an adhesive method according to the present invention;

FIG. 2 is a perspective view showing a first method of applying a resin on a first optical component and a second optical component according to the present invention;

FIG. 3 is a perspective view showing a second method of applying the resin on the first and second optical components according to the present invention;

FIG. 4 is a plan view showing the first optical component being arranged to correspond to the second optical component through a first supporting apparatus and a second supporting apparatus according to the present invention;

FIG. 5 is a plan view illustrating a resin bridge being formed between the first optical component and the second optical component according to the present invention;

FIG. 6 is a perspective view showing the resin bridge being formed between the first optical component and the second optical component according to the present invention;

FIG. 7 is a plan view illustrating the distance between the first optical component and the second optical component being shortened according to the present invention;

FIG. 8 is a perspective view showing the resin being spread over a first predetermined area of the first optical component and a second predetermined area of the second optical component according to the present invention;

FIG. 9 is a plan view illustrating the second supporting apparatus releasing the second optical component to make the resin to spread to be fully filled between the first optical component and the second optical component through the second optical component pressing the resin according to the present invention; and

FIG. 10 is a perspective view showing the resin being spread to be fully filled between the first optical component and the second optical component according to the present invention.

### DETAILED DESCRIPTION OF THE PREFERRED EMBODIMENT

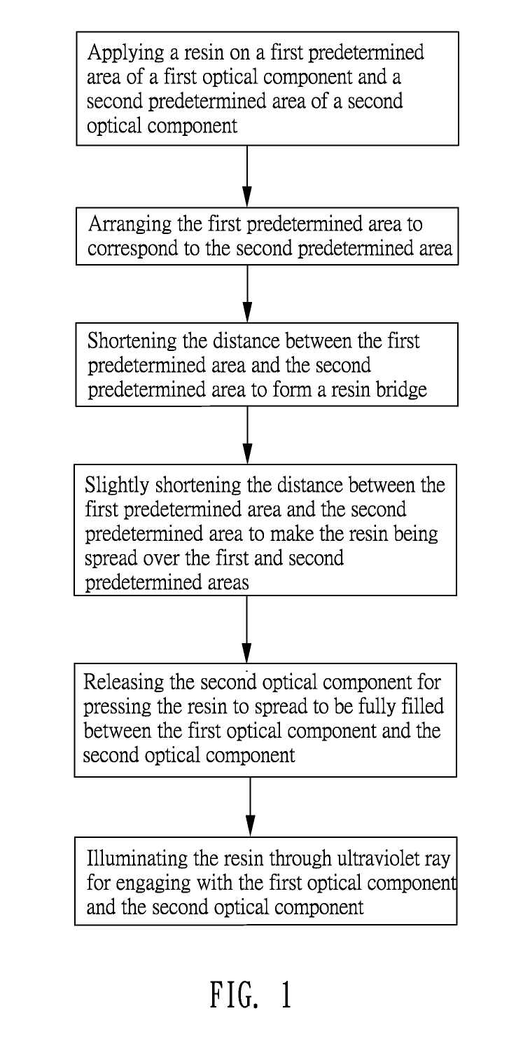

Firstly referring to FIG. 1, a flow chart of an adhesive method of optical components according to the present invention includes several steps which are described afterward.

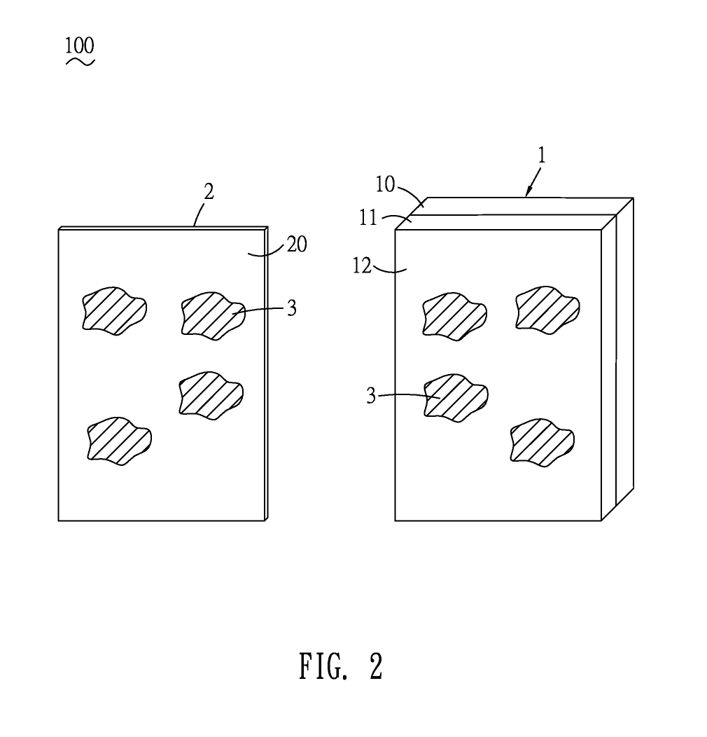

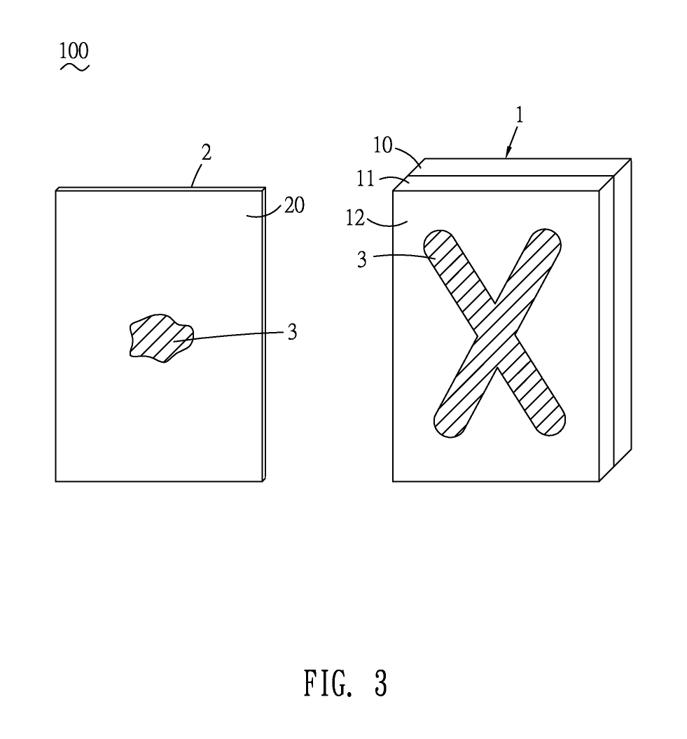

Please refer to FIG. 2 and FIG. 3, in a preferred embodiment, the adhesive method is applied to a first optical component 1 and a second optical component 2 of a liquid crystal module 100 adhered to each other. In this case, the first optical component 1 includes a liquid crystal plane 10 and a polarizing plate 11 located on a surface of the liquid crystal plane 10. The second optical component 2 can be a protective plate, a touch panel and etc.

Firstly, a resin 3 is applied on a first predetermined area of a first coating surface 12 of the first optical component 1 and a second predetermined area of a second coating surface 20 of the second optical component 2. In this case, the second coating surface 12 is the surface of the polarizing plate 11 removed from the liquid crystal plane 10.

Still refer to FIG. 2 and FIG. 3. A first applying method of the resin 3 is shown in FIG. 2. The first and second predetermined areas can be several small areas which are dispersed on the first coating surface 12 and the second coating surface 20 and corresponded to each other. A second applying method of the resin 3 is shown in FIG. 3. The first predetermined area can be a special shape such as X-shape, and the second predetermined area can be at least one small area corresponding to the special shape, for example, the second predetermined area is a small area corresponding to the central area of the X-shape.

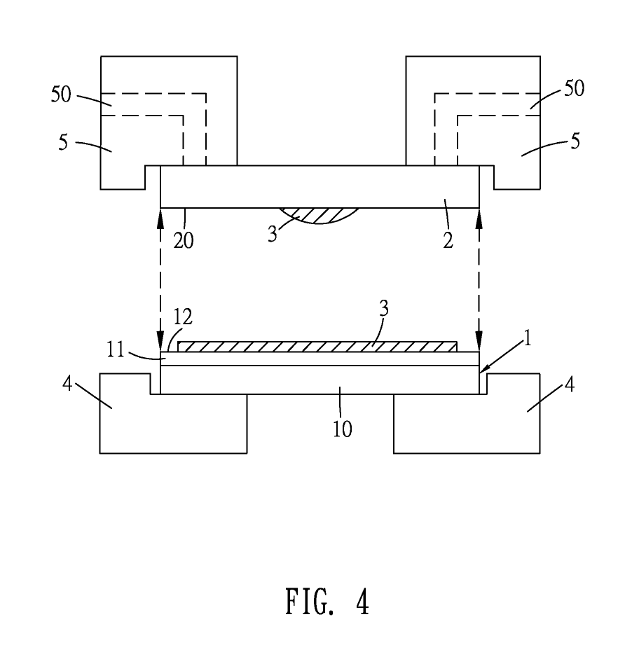

As shown in FIG. 4, after the resin 3 is applied on the first and second predetermined areas, the first optical component 1 is arranged at a first supporting apparatus 4 and the second optical component 2 is arranged at a second supporting apparatus 5. The second supporting apparatus 5 has a fixing device 50 for fixing the second optical component 2. In this case, the fixing device 50 is a suction machine. The first and second supporting apparatuses 4, 5 support the first and second optical components 1, 2 respectively and arrange the first and second optical components 1, 2 to correspond to each other.

In another embodiment, the first supporting apparatus 4 can support the second optical component 2 and the second supporting apparatus 5 can support the first optical component 1. The first optical component 1 is fixed to the second supporting apparatus 5 through the fixing device 50. Therefore, the first predetermined area of the first optical component 1 is arranged to correspond to the second predetermined area of the second optical component 2.

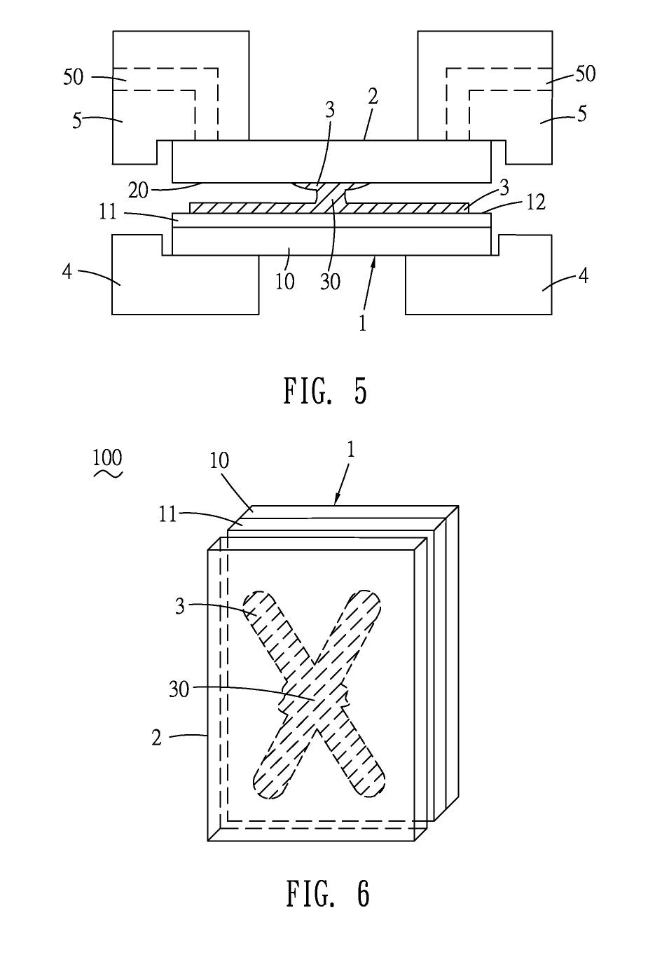

Please refer to FIG. 5 and FIG. 6. After the first and second predetermined areas are arranged to correspond to each other, the distance between the first optical component 1 and the second optical component 2 is shortened until the resin 3 applied on the first optical component 1 connects with the resin 3 applied on the second component 2 to form a resin bridge 30. In this case, the first supporting apparatus 4 moves toward the second supporting apparatus 5 until the resin bridge 30 is formed between the first optical component 1 and the second optical component 2. In other wards, the second supporting apparatus 5 can move toward the first supporting apparatus 4 until the resin bridge 30 is formed or the first supporting apparatus 4 and the second supporting apparatus 5 move to each other until the resin bridge 30 is formed.

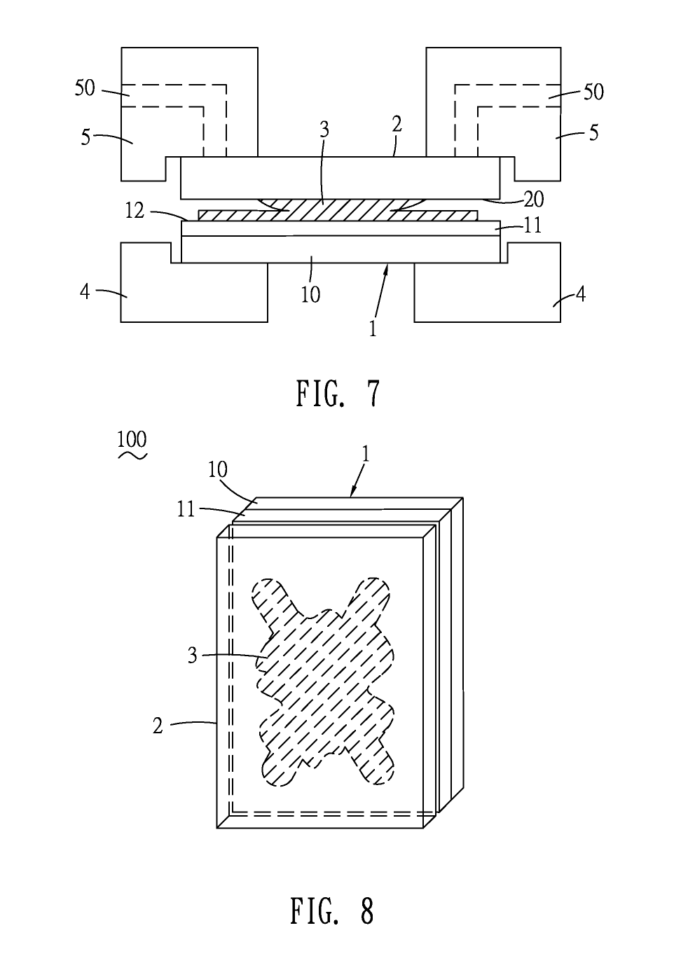

As shown in FIG. 7 and FIG. 8, after the resin bridge 30 is formed between the first optical component 1 and the second optical component 2, the distance between the first optical component 1 and the second optical component 2 is slightly shortened and then the resin 3 is pressed by the first optical component 1. The resin 3 is therefore spread over the first and second predetermined areas.

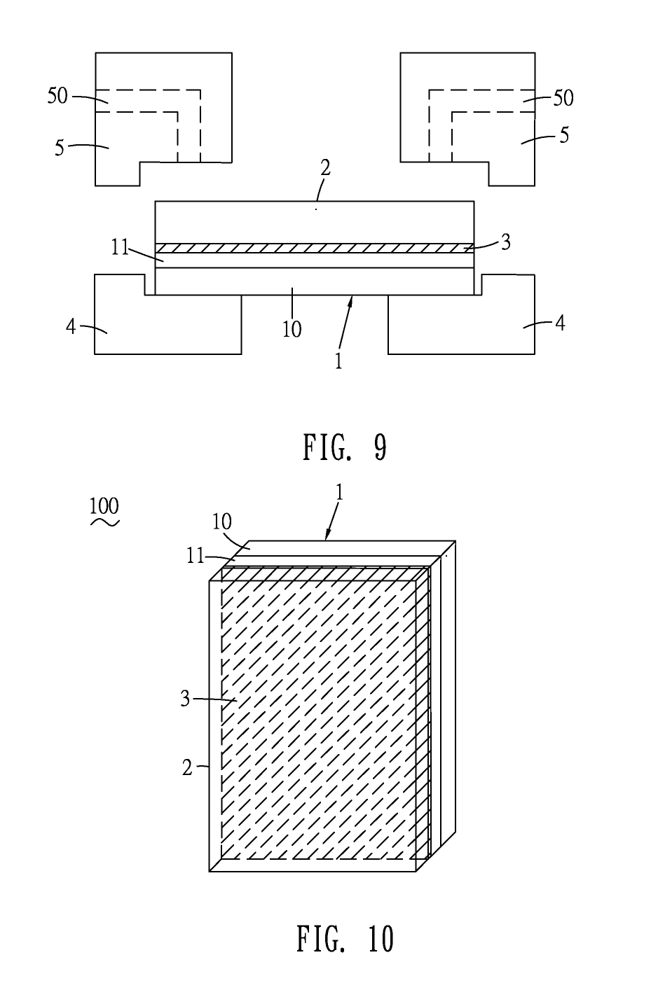

Please refer to FIG. 9 and FIG. 10. When the fixing device 50 releases the second optical component 2, the second optical component 2 presses the resin 3 to make the resin 3 spread on the first coating surface 12 and the second coating surface 20. Therefore the resin 3 is fully filled between the first optical component 1 and the second optical component 2. Finally, the resin 3 is illuminated through ultraviolet ray for engaging with the first optical component 1 and the second optical component 2.

After the resin 3 is applied on the first predetermined area of the first optical component 1 and the second predetermined area of the second optical component 2, the distance between the first and second predetermined areas is shortened until the resin bridge 30 is formed, and then the resin 30 is fully filled between the first and second optical components 1, 2 through the second optical component 2 pressing the resin 3, and finally the resin 3 is illuminated through ultraviolet ray, the resin 3 engages with the first and second optical components 1, 2.

Because the resin 3 is fully filled between the first optical component 1 and the second optical component 2, the liquid crystal module 100 can be downsized and the display quality of the liquid crystal module 100 can be enhanced. Further, the liquid crystal module 100 is adapted to configure in a small size electrical apparatus such as a mobile phone, a personal digital assistant and a digital camera.

The foregoing description of various implementations has been presented for the purposes of illustration and description. It is not intended to be exhaustive or to limit the scope to the precise form disclosed. Many modifications and variations are possible in light of the above teaching. Such modifications and variations are intended to be included within the scope of this invention as defined by the accompanying claims.

What is claimed is:

1. An adhesive method of optical components, comprising:
applying a resin on a first predetermined area of a first optical component and a second predetermined area of a second optical component;
supporting said first and second optical components through a first supporting apparatus and a second supporting apparatus, and fixing said second optical component through a fixing component for arranging said first predetermined area corresponding to said second predetermined area;
shortening the distance between said first supporting apparatus and said second supporting apparatus until said resin which is applied on said first and second predetermined areas respectively being connected to each other to form a resin bridge;
lightly shortening the distance between said first supporting apparatus and said second supporting apparatus for said resin being spread over said first and second predetermined areas;
by said fixing device releasing said second optical component, said second optical component pressing said resin for said resin being spread to be fully filled between said first optical component and said second optical component; and
illuminating said resin through ultraviolet ray for said resin engaging with said first and second optical components.

2. The adhesive method of optical components as claimed in claim 1, wherein said first optical component has a liquid crystal plane and a polarizing plate, said resin is applied on said first predetermined area of the surface of said polarizing plate removed from said liquid crystal plane.

3. The adhesive method of optical components as claimed in claim 1, wherein said second optical component is a protective plate.

4. The adhesive method of optical components as claimed in claim 1, wherein said second optical component is a touch panel.

5. The adhesive method of optical components as claimed in claim 1, wherein said fixing device is a suction machine.

6. An adhesive method of optical components, comprising:
applying a resin on a first predetermined area of a first optical component and a second predetermined area of a second optical component;
arranging said first predetermined area of said first optical component to correspond to said second predetermined area of said second optical component;
shortening the distance between said first predetermined area of said first optical component and said second predetermined area of said second optical component until said resin which is applied on said first and second predetermined areas being connected to each other to form a resin bridge;
lightly shortening the distance between said first predetermined area of said first optical component and said second predetermined area of said second optical component for said resin being spread over said first and second predetermined areas;
by means releasing said second optical component, said second optical component pressing said resin for said resin being spread to be fully filled between said first optical component and said second optical component; and
illuminating said resin through ultraviolet ray for engaging with said first and second optical component.

7. The adhesive method of optical components as claimed in claim 6, wherein said first optical component has a liquid crystal plane and a polarizing plate, said resin is applied on said first predetermined area of the surface of said polarizing plate, the surface of said polarizing plate is removed from said liquid crystal plane.

8. The adhesive method of optical components as claimed in claim 6, wherein said second optical component is a protective plate.

9. The adhesive method of optical components as claimed in claim 6, wherein said second optical component is a touch panel.

10. The adhesive method of optical components as claimed in claim 6, wherein said first optical component is supported by a first supporting apparatus and said second optical component is supported by a second supporting apparatus, said second supporting apparatus has a fixing device for fixing said second optical component, wherein the distance between said first optical component and said second optical component is shortened by shortening the distance between said first supporting apparatus and said second supporting apparatus, by said fixing device releasing said second optical component, said second optical component presses said resin for said resin being spread to be fully filled between said first optical component and said second optical component.

11. The adhesive method of optical components as claimed in claim 10, wherein said fixing device is a suction machine.
